(19) United States
(12) Patent Application Publication
(10) Pub. No.: US 2019/0028304 A1
(43) Pub. Date: Jan. 24, 2019

(54) TIME REVERSAL IN WIRELESS COMMUNICATIONS

(71) Applicant: Ziva Corporation, San Diego, CA (US)

(72) Inventors: Jeremy Rode, San Diego, CA (US); Mark Hsu, La Jolla, CA (US); Maha Achour, Encinitas, CA (US); David Smith, Ellicott City, MD (US); Anis Husain, San Diego, CA (US); Kris Gregorian, Encinitas, CA (US)

(73) Assignee: Ziva Corporation, San DIego, CA (US)

(21) Appl. No.: 15/553,886

(22) PCT Filed: Feb. 22, 2016
(86) PCT No.: PCT/US2016/018968

§ 371 Date: Jun. 1, 2018

Related U.S. Application Data
(60) Provisional application No. 62/126,437, filed on Feb. 27, 2015.

(51) Int. Cl. H04L 25/02; H04L 25/03; H04L 27/26; H04L 23/02

(52) U.S. Cl. CPC H04L 25/0212; H04L 23/02; H04L 27/2634; H04L 25/03343

(57) ABSTRACT

In examples, Time-Reversal (TR) Orthogonal Frequency-Division Multiplexing (OFDM) communications employ adaptive filtering on a per-subcarrier basis. Matched filtering is used for subcarriers with poor transmission properties (such as relatively high channel attenuation), while inverse filtering is used for subcarriers with relatively good transmission properties (such as relatively low channel attenuation). Modulation order may be reduced for the subcarriers with poor properties (relative to the subcarriers with good properties). The discovery of subcarrier properties may be performed through the channel state information measured and reconciled from single- and/or bi-directional TR sounding signals. The discovery may be repeated, for example, performed continually. In response to changes in traffic and other environmental conditions, the system may be reconfigured dynamically with different subcarriers selected for matched and inverse filtering. In examples, a normalized signal-to-noise ratio threshold dividing good and poor transmission properties is computed based on an acceptable symbol error rate.

### CROSS-REFERENCE TO RELATED APPLICATIONS

The present application claims priority from U.S. Provisional Patent Application Ser. No. 62/126,437, entitled TIME REVERSAL IN WIRELESS COMMUNICATIONS, filed on 27 Feb. 2015. The above-identified patent document is hereby incorporated by reference in its entirety as if fully set forth herein, including text, figures, claims, tables, computer program listing appendices, and all other matter (if present).

### FIELD

This document relates generally to communications. In particular examples, this document relates to the field of Time Reversal (TR) communications using Orthogonal Frequency Division Multiplexing (OFDM).

### BACKGROUND

Time reversal communications allow temporal and spatial focusing of transmissions on intended receivers. Such communications are described in several documents, including the following commonly-owned patent documents:
1. International Patent Publication WO/2012/151316 (PCT/US2012/36180), entitled DISTRIBUTED CO-OPERATING NODES USING TIME REVERSAL, filed 2 May 2012;
2. U.S. patent application Ser. No. 14/114,901, Publication Number 2014-0126567, entitled DISTRIBUTED CO-OPERATING NODES USING TIME REVERSAL, filed on 30 Oct. 2013;
3. U.S. Provisional Patent Application Ser. No. 61/481,720, entitled DISTRIBUTED CO-OPERATING NODES USING TIME REVERSAL FOR COMMUNICATIONS, SENSING & IMAGING, filed on 2 May 2011;
4. U.S. Provisional Patent Application Ser. No. 61/540,307, entitled DISTRIBUTED CO-OPERATING NODES USING TIME REVERSAL FOR COMMUNICATIONS, SENSING & IMAGING, filed on 28 Sep. 2011;
5. U.S. Provisional Patent Application Ser. No. 61/809,370, entitled APPARATUS, METHODS, AND ARTICLES OF MANUFACTURE FOR COLLABORATIVE BEAMFOCUSING OF RADIO FREQUENCY EMISSIONS OF RADIO FREQUENCY EMISSIONS, filed on 7 Apr. 2013;
6. U.S. Provisional Patent Application Ser. No. 61/829,208, entitled APPARATUS, METHODS, AND ARTICLES OF MANUFACTURE FOR COLLABORATIVE BEAMFOCUSING OF RADIO FREQUENCY EMISSIONS, filed on 30 May 2013;
7. International Patent Application PCT/US2014/033234, entitled DISTRIBUTED CO-OPERATING NODES USING TIME REVERSAL, filed 7 Apr. 2014;
8. U.S. patent application Ser. No. 14/247,229, entitled DISTRIBUTED CO-OPERATING NODES USING TIME REVERSAL, filed on 7 Apr. 2014;
9. U.S. Provisional Patent Application Ser. No. 61/881,393, entitled APPARATUS, METHODS, AND ARTICLES OF MANUFACTURE FOR COLLABORATIVE ARRAY COMMUNICATIONS INLUDING BEAMFOCUSING OF EMISSIONS, filed on 23 Sep. 2013;
10. U.S. patent application Ser. No. 14/476,738, entitled SYNCHRONIZATION OF DISTRIBUTED NODES, filed on 4 Sep. 2014; and
11. U.S. patent application Ser. No. 14/494,580, entitled SYNCHRONIZATION OF DISTRIBUTED NODES, filed 23 Sep. 2014.

Each of the patent documents identified above is hereby incorporated by reference, including specification, claims, figures, tables, and all other matter in the patent document. We may refer to these documents collectively as “incorporated applications” or “related patent documents.”

Time reversal may bring various benefits to systems using one or more antennas at the receiving node, transmitting node, or both the receiving and the transmitting nodes. The term Single-Input-Single-Output (“SISO”) refers to systems where a single antenna is used on the receive side and a single antenna is used on the transmit side. The term Multiple-Input-Single-Output (“MISO”) refers to systems that transmit signals from multiple (N_{T}) antennas, which signals are generally received by one antenna on the receive side. And the term MIMO refers to systems where the transmitter has multiple (N_{T}) antennas as in MISO, but the receiver is also equipped with multiple (N_{R}) antennas.

Orthogonal Frequency-Division Multiplexing is a technique of communicating digital data on multiple subcarrier frequencies. Thus, in communication systems using OFDM techniques, the information to be communicated may be divided into data sub-streams transmitted (generally in parallel) over multiple subcarriers; the subcarriers may be equally spaced over the channel bandwidth, so that the sum of the subcarrier operating bands is generally equal to the total communication channel bandwidth. For example, a conventional time-domain continuous signal s(t) may be transmitted using a single center carrier f_{c}, over a channel bandwidth W. In OFDM, multiple sub-stream signals sᵢ(t) may be transmitted in parallel over the communication channel using multiple subcarriers f; over a total channel bandwidth Nc ΔW=Nc(fᵢ₊₁−fᵢ), where i=1, . . . , N_{c}, The number of the subcarriers N_{c} may be a power of 2. In the relevant parlance, each subcarrier and the frequency band associated with it may be referred to as a “bin.”

There are needs in the art to improve reliability, robustness, efficiency, and/or other beneficial characteristics of communications, and, in particular, TR communications using OFDM.

### SUMMARY

Embodiments, variants, and examples described in this document are directed to methods, apparatus, and articles of manufacture that may satisfy one or more of the above described and/or other needs.

In an embodiment, a method of wirelessly communicating between a first node and a second node using Radio Frequency (RF) Orthogonal Frequency-Division Multiplexing (OFDM) with a plurality of subcarriers and time-reversal, includes: estimating channel between the first node and the second node for each subcarrier of the plurality of subcarriers, thereby obtaining a plurality of channel state information (CSI) estimates, a CSI estimate of the plurality of CSI estimates per subcarrier of the plurality of subcarriers, each subcarrier of the plurality of subcarriers being associated with a CSI estimate of the plurality of CSI estimates corresponding to said each subcarrier; and transmitting data from the first node to the second node using inverse filtering for subcarriers of the plurality of subcarriers associated with CSI estimates that meet at least one channel quality criterion, and matched filtering for subcarriers of the plurality of subcarriers associated with CSI estimates that do not meet the at least one channel quality criterion.

In aspects, the first node is an access point configured to communicate with a plurality of client devices, which plurality includes the second node.

In aspects, estimating includes transmitting a sounding signal from the second node to the first node.

In aspects, estimating includes receiving by the first node a sounding signal transmitted from the second node.

In aspects, the inverse filtering is performed so that total transmitted power is subjected to a transmit power constraint imposed on the first node.

In aspects, the matched filtering is performed so that at least some of the subcarriers that do not meet the at least one channel quality criterion are stuffed with a predetermined value.

In aspects, transmitting is performed so that the data is sent from the first node to the second node using inverse filtering for the subcarriers of the plurality of subcarriers associated with the CSI estimates that meet the at least one channel quality criterion, and using matched filtering with reduced modulation order for at least some of the subcarriers associated with the CSI estimates that do not meet the at least one channel quality criterion.

In aspects, the at least one channel quality criterion includes a channel attenuation threshold, each CSI estimate of the plurality of CSI estimates includes a channel attenuation estimate corresponding to the subcarrier associated with said each CSI estimate, and CSI estimates that meet the at least one channel quality criterion indicate attenuation less than the channel attenuation threshold, and CSI estimates that do not meet the at least one channel quality criterion indicate attenuation not less than the channel attenuation threshold.

In aspects, the method also includes setting a target symbol error rate (TSER), and computing the at least one channel quality criterion based on the TSER.

In aspects, the at least one channel quality criterion includes a normalized signal-to-noise ratio threshold; each CSI estimate of the plurality of CSI estimates comprises a channel normalized signal-to-noise ratio estimate corresponding to the subcarrier associated with said each CSI estimate; CSI estimates that meet the at least one channel quality criterion indicate normalized signal-to-noise ratio greater than the normalized signal-to-noise ratio threshold

$$( Th \frac{{E}_{b}}{{N}_{0}} ) ,$$

and CSI estimates that do not meet the at least one channel quality criterion indicate normalized signal-to-noise ratio not greater than the normalized signal-to-noise ratio threshold

$$( Th \frac{{E}_{b}}{{N}_{0}} ) .$$

In aspects, Quadrature Amplitude Modulation (QAM) is used for transmission, and the method also includes setting a target symbol error rate (TSER) for said each subcarrier, and computing the normalized signal-to-noise ratio threshold

$$Th \frac{{E}_{b}}{{N}_{0}}$$

based on the TSER according to the following formula:

$$Th \frac{{E}_{b}}{{N}_{0}} = \frac{2 ( {2}^{R} - 1 )}{3 R} \cdot {[ {erfc}^{- 1} ( \frac{TSER}{2} ) ]}^{2} ,$$

in which formula R is the number of bits in the QAM.

In embodiments, the steps described above (and elsewhere in this document) are stored in a machine-readable memory, in a non-transitory manner.

In an embodiment, a Radio Frequency (RF) wireless communication node includes a receiver, a transmitter, a storage device storing program code, and a processor coupled to the receiver, the transmitter, and the storage device. The processor reads the program code from the storage device and executes the program code to configure the communication node to estimate channel between the communication node and another node for a plurality of Orthogonal Frequency-Division Multiplexing (OFDM) subcarriers, thereby obtaining a plurality of channel state information (CSI) estimates, a CSI estimate of the plurality of CSI estimates per subcarrier of the plurality of subcarriers, each subcarrier of the plurality of subcarriers being associated with a CSI estimate of the plurality of CSI estimates corresponding to said each subcarrier; and transmit data to said another node using inverse filtering for subcarriers of the plurality of subcarriers associated with CSI estimates that meet at least one channel quality criterion, and matched filtering for subcarriers of the plurality of subcarriers associated with CSI estimates that do not meet the at least one channel quality criterion.

In an embodiment, a wireless Radio Frequency (RF) communication node includes a receiver, a transmitter, a storage device storing program code, and a processor coupled to the receiver, the transmitter, and the storage device. The processor reads program code from the storage device and executes the program code to configure the node to obtain estimates of channel between the node and another node for a plurality of Orthogonal Frequency-Division Multiplexing (OFDM) subcarriers; receive data from said another node using inverse filtering for subcarriers of the plurality of subcarriers that meet one or more channel quality criteria, and using Time-Reversal matched filtering for subcarriers of the plurality of subcarriers that do not meet the one or more channel quality criteria.

These and other embodiments, features, and aspects of the present invention (or inventions, as the case may be) will be better understood with reference to the following description, drawings, and the appended claims.

### BRIEF DESCRIPTION OF THE FIGURES

FIG. 1 illustrates an example of a multi-user wireless indoor network;

FIGS. 2A and 2B illustrate selected elements of apparatus configured in accordance with one or more features described in this document;

FIG. 3 illustrates selected blocks of a transmitter configured in accordance with one or more features described in this document;

FIG. 4 illustrates selected blocks of a receiver configured in accordance with one or more features described in this document;

FIG. 5 illustrates selected steps and blocks used to implement adaptive mapping in accordance with one or more features described in this document;

FIGS. 6-14 illustrate selected aspects of examples of TR-MIMO system, in accordance with one or more features described in this document;

FIGS. 15-18 illustrate selected aspects of Access Point and user devices operation in a multi-user environment, in accordance with one or more features described in this document;

FIG. 19 illustrates selected aspects of an example of aggregation of multiple Access Points in a distributed manner to act as a backhaul in a multi-user network, in accordance with one or more features described in this document; and

FIG. 20 illustrates selected aspects of a multi-user network using multiple antennas on the Access Point and clients' sides, in accordance with one or more features described in this document.

### DETAILED DESCRIPTION

The words “embodiment,” “variant,” “example,” and similar words and expressions as used here refer to a particular apparatus, process, or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place or context may refer to a different apparatus, process, or article of manufacture. The expression “alternative embodiment” and similar words and expressions are used to indicate one of a number of different possible embodiments, variants, or examples. The number of possible embodiments, variants, or examples is not necessarily limited to two or any other quantity. Characterization of an item as “exemplary” means that the item is used as an example. Such characterization does not necessarily mean that the embodiment, variant, or example is preferred; the embodiment, variant, or example may but need not be a currently preferred embodiment, variant, or example. All embodiments, variants, and examples are described for illustration purposes and are not necessarily strictly limiting.

The words “couple,” “connect,” and similar expressions and words with their inflectional morphemes do not necessarily import an immediate or direct connection, but include within their meaning connections through mediate elements.

The expression “processing logic” should be understood as selected steps/decision blocks and/or hardware/software/firmware for implementing the selected steps/decision blocks. “Decision block” means a step in which a decision is made based on some condition, and process flow may be altered based on whether the condition is met or not.

An “access point,” “Access Point,” and AP refer to a device that allows wireless devices to connect to a wired network using Wi-Fi, or related standards, as the term is generally understood.

References to “receiver” (“Rx”) and “transmitter” (“Tx”) are made in the context of examples of data transmission from a transmitter to an intended or target receiver. For time-reversal communication techniques, the intended or target receiver may need to transmit to the transmitter a sounding signal, e.g., a pulse/burst or a pilot signal, and the transmitter may need to receive the sounding signal. Moreover, data communications can be bi-directional, with transceivers on both sides. In this document, the client nodes may be “transmitters” of data, which they transmit to an “intended receiver” (or “targeted receiver,” “target receiver,” “target Rx,” or simply “target”), such as an access point. The roles may be reversed, with one or more client nodes also or instead being the intended or target receiver for the transmissions from one or more access points. In the event that the ascribed meaning is different in a particular context, we will specify in the context what configuration is being discussed.

A “target” thus may be an entity that emits a sounding signal, and may generally include both transmit and receive functionality. Note that although we may occasionally refer to a target (or equivalent terms) in the singular, the general description of the processes and systems involved applies to multiple targets; as is discussed in this document and the related patent documents, nodes may transmit to multiple targets at different times, simultaneously, and/or using transmissions that partially overlap in time. Note also that a target may be a source of cooperative and/or opportunistic transmissions used for “sounding,” and that sounding may be received by the target, which then transmits channel information derived from the sounding back to the transmitter. The “sounding” term is further explained below. Note that the definition of “target” in the preceding sentences of this paragraph does not apply to the “target” symbol error rate, which is simply the desired limit on the symbol error rate, or to similar expressions.

In TR systems, the nodes (e.g., the AP and the user or client nodes communicating uni- or bi-directionally with the AP) need to have knowledge of the channel to set their respective TR pre-filters. There are several ways to accomplish this. In IEEE 802.11ac systems, for example, the AP may send a multicast sounding pulse to all client nodes in its cell to derive the channel impulse responses (CIRs) or other types of channel responses (CRs) for the respective nodes, and then each client node may send back the measured and quantized channel state information (“CSI,” which may describe or be equivalent to the CSI, and which concept includes within its meaning CIR/CR) back to the AP, either alone or together with other information such as the user data. As another example, each client node may send the channel monitoring signal (sounding signal) to the AP for the AP to derive the CIR; this scheme typically has a higher level of network complexity to coordinate the different soundings from the different client nodes. In each of the cases described in the preceding sentences of this paragraph, the higher the number of quantization bits, the longer is the overhead, because of the larger number of CIR/CR bits transmitted. Conventional MIMO and beamforming/nulling typically require between 4- and 8-bit quantization levels for effective implementation, whereas in selected systems and methods described in this document, TR may maintain spatial and temporal focusing even with a one-bit quantization. Note, however, that systems and methods with higher bit numbers of quantization are not necessarily excluded from the scope of the claims.

Some definitions have been explicitly provided above. Other and further explicit and implicit definitions and clarifications of definitions may be found throughout this document.

We now describe, among other aspects, techniques for implementing TR in the frequency domain using OFDM in conjunction with multiple Tx and/or Rx antennas for single user (client device) and multi-user communications. An adaptive mapping of transmitted data to OFDM subcarrier is identified to avoid using (or reducing the power and/or modulation order of) data transmissions over the OFDM subcarriers with poor performance. In embodiments, no data is transmitted over poorly performing subcarriers. In other embodiments, lower modulation order is used in poorly performing subcarriers. The modulation order of a digital communication scheme is generally determined by the number of the different symbols that can be transmitted using the modulation order. For binary-based logic, modulation schemes generally use modulation orders that are powers of two, for example, 2, 4, 8, 16, 32, and so on. Quadrature phase shift keying or QPSK has a modulation order of 4. Lowering the modulation order may be accomplished, for example, by reducing the integer m in m-ary modulation.

In MIMO implementations, various coding schemes that assign and/or duplicate different data streams to transmit antennas may be identified to increase data rate while benefiting from TR open-loop pre-filtering techniques. In multi-user applications, algorithms and networking protocols are detailed to leverage TR spatial focusing to beamform the signal designated to a particular client device, while possibly nulling (or reducing) its strength in other directions.

Time-reversal communications use (1) “sounding” of a channel; and then (2) applying pre-filtering to the transmitted data, e.g., time-reversing the channel response (the channel response from the target of the transmission to the source of the transmission) and convolving it with the data to be transmitted. “Sounding” and its inflectional morphemes refer to transmitting a signal for the purpose of obtaining information about the channels, for example, for forming TR signals. Sounding may also be opportunistic, that is, the sounding signal may be transmitted for another purpose but also used for obtaining the channel state information. Sounding in the context of TR communications is described in the commonly-owned and related patent documents.

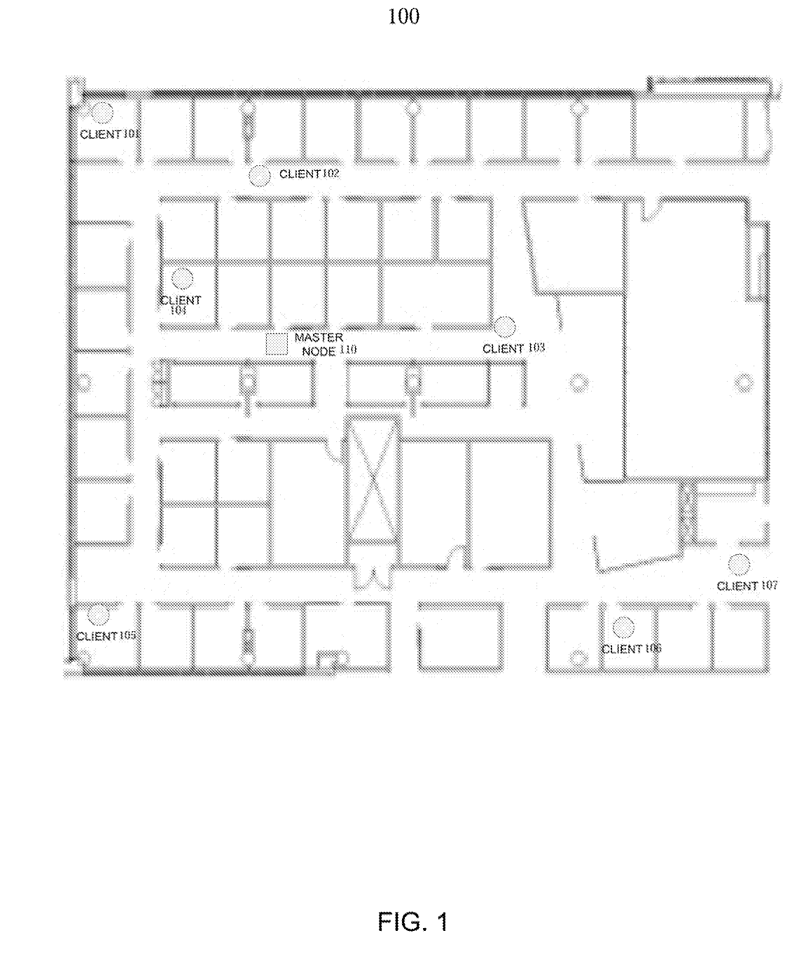

FIG. 1 illustrates an example of a multi-user wireless indoor network 100 where the master node 110 transmits data to and/or receives data from users (client nodes 101-107) in a star network configuration. The master node 110 can be, for example, an Access Point (AP), a Hot-Spot (a device providing Internet access over a wireless local area network and a router connected to link to an Internet service provider), or a micro/femto Base Station, and the users 101-107 may be referred to as clients. Furthermore, the wireless network that encompasses one master node and users may be referred to as a communication “cell.” In this example and in the other examples described in this document, any of the communication paths between the master node 110 and one of the client nodes 101-107 may be Line-of-Sight (LOS) or Non Line-of-Sight (NLOS). Time reversal may be applied to both LOS and NLOS links. The benefits of TR, however, are typically more significant in NLOS cases, and especially in low Signal-to-Noise-Ratio (SNR) NLOS conditions.

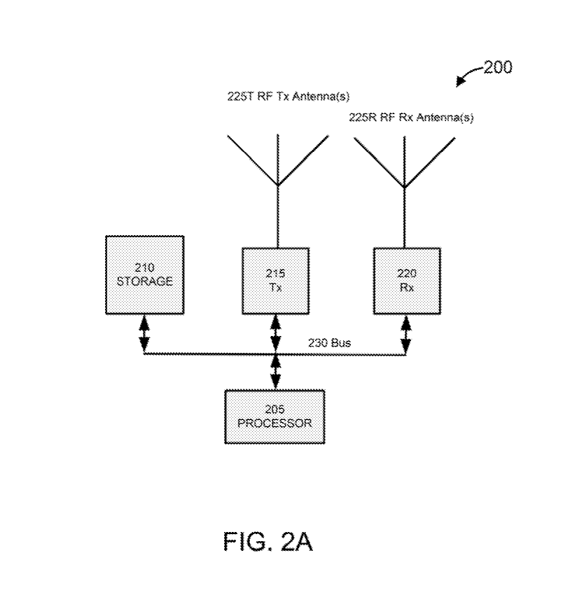

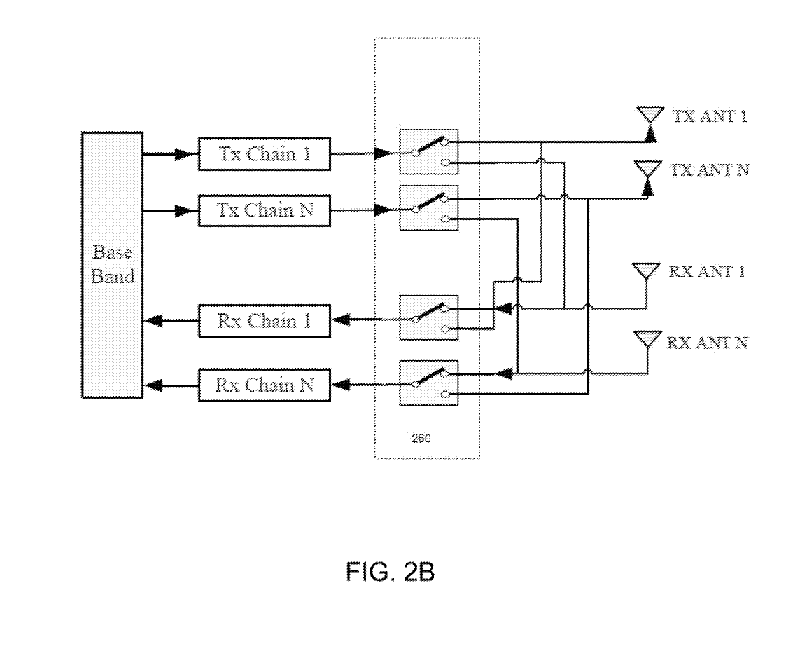

FIG. 2A illustrates selected elements of an apparatus 200 configured in accordance with one or more features described in this document. The apparatus may be a node in a network configured to communicate using RF and TR, for example, an access point or a client node communicating with the access point and/or other devices. The apparatus may include:
(1) a processor 205 (or a processor subsystem, which may include one or more processors, as well as other components);
(2) one or more storage devices 210, which may store program code for execution by the processor 205 and other applications that use digital storage, and which may also be used for digitally storing the sounding signal, CR/CIR, CSI;
(3) at least one RF receiver 220 configured to receive radio frequency signals from the receiving antenna 225R connected to the particular RF receiver 220, such as sounding signals and data transmission signals which may emanate from the Access Point or a client node;
(4) the receiving antennas 225R, e.g., one receiving antenna 225R per RF receiver 220;
(5) at least one RF transmitter 215 configured to transmit radio frequency signals from the transmitting antenna 225T, such as sounding signals and/or data to the Access Point and/or client devices through the transmitting antenna 225T connected to the particular transmitter 215;
(6) the transmitting antennas 225T, e.g., one transmitting antenna 225R per RF transmitter 215; and
(7) a bus (or busses) 230 coupling the processor 205 to the storage device 210, the receiver 220, and the transmitter 215, and allowing the processor 205 to read from and write to these devices, and otherwise to control operation of these devices.

In embodiments, additional receivers, transmitters, and/or other devices are present and coupled to the processor 205.

Note that the same antenna may be connected to both one of the RF receivers 220 and one of the RF transmitters 215, and serve as a receiving antenna and a transmitting antenna. In a half-duplex communication, for example, each antenna may be connected to one of the transmit/receive radios (also referred to as transceivers) which switches between transmit and receive functionalities. In full-duplex communication, the transmit and receive antennas may each be connected to the transmit and receive radios, respectively. As is illustrated in FIG. 2B, a switch 260 selectively connecting each antenna to (1) a receiver and (2) a transmitter, operating in such a way that the sounding and TR pre-filtering occur by switching between the two switch positions.

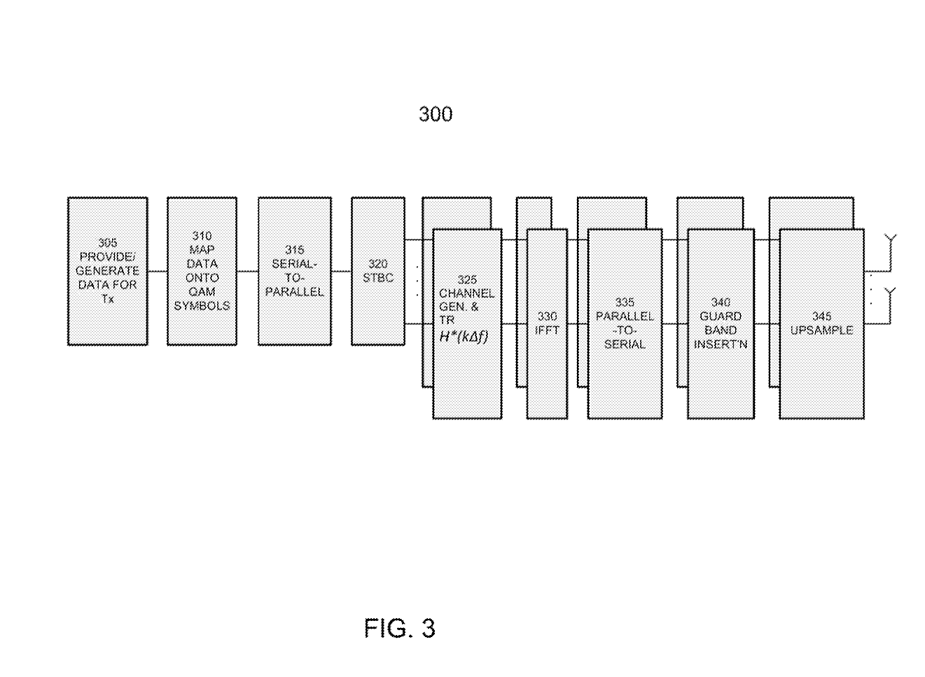

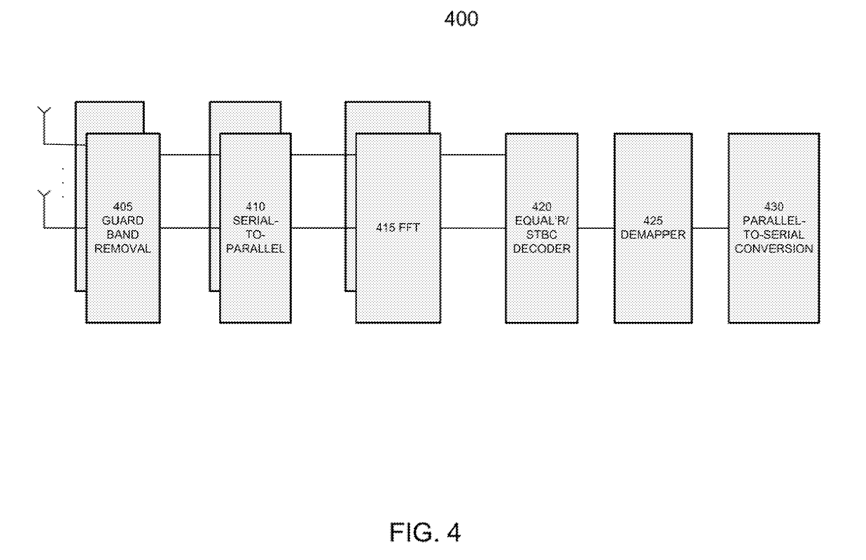

FIGS. 3 and 4 illustrate selected blocks of a TR-OFDM transmitter 300 and a TR-OFDM receiver 400, respectively. Here, as in other examples of this document, some of the blocks may be optional in some embodiments, and/or other processing logic blocks may be added. In FIG. 3, processing block 305 provides data to be transmitted, such as user data intended for the user node receiver 400 of FIG. 4. Processing block 310 maps the data to be transmitted onto Quadrature Amplitude Modulation (QAM) symbols (or other modulation symbols). Processing block 315 performs serial-to-parallel conversion, so that the stream of the symbols outputted by the block 310 is broken up into a number of substreams corresponding to different OFDM subcarriers. Processing block 320 performs a Space Time Block Coding (STBC) function. Processing blocks 325-345 perform, respectively, time reversal, inverse Fourier Transform function (IFFT), parallel-to-serial conversion, guard band addition, and upsampling. In addition to using OFDM, higher modulation QAM mappings, and MIMO coding suitable for TR communication, cyclic prefix and error correction coding, as well as other functionality not shown in the figures may be added to lower the error rate and for other purposes. Guard intervals may be added (340) at each subcarrier to reduce Inter-Symbol-Interference (ISI) and inter-subcarrier-interference. Note that there may be a separate chain of processing blocks 325-345 per transmit antenna or a subset of transmit antennas.

In FIG. 4, processing blocks 405-430, respectively, remove guard bands, perform serial-to-parallel conversion, perform Fast Fourier Transform (FFT) processing, equalization with STBC decoding, demapping, and parallel-to-serial conversion. Note that there may be a separate chain of processing blocks 405-415 per receive antenna or a subset of receive antennas.

In some embodiments, adaptive mapping of transmitted data to OFDM subcarriers is employed to avoid using or reducing data transmission over the subcarriers with poor performance. In embodiments, no data is transmitted over poorly performing subcarriers for an overall reduced data rate. In embodiments, lower order modulation is used in poorly performing subcarriers to maintain reliable links without drastically reducing the data rate.

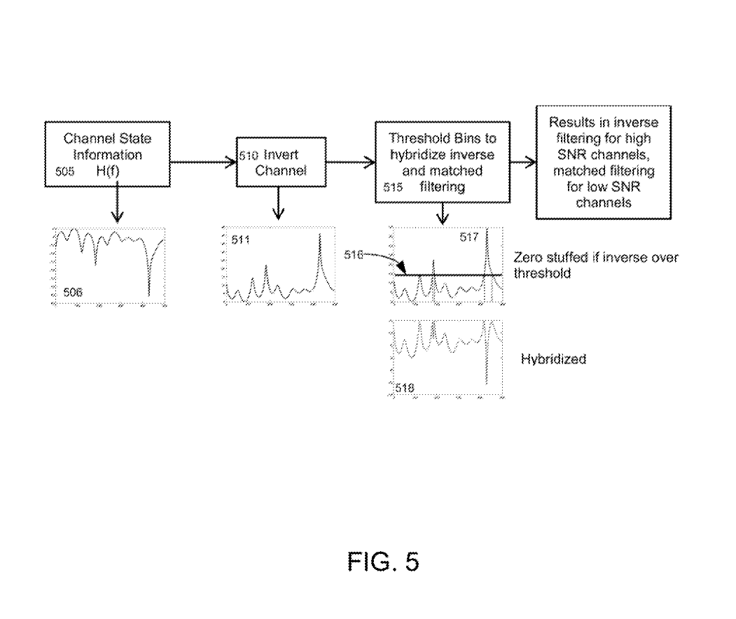

FIG. 5 illustrates the steps and blocks used to implement adaptive mapping in which inverse filtering and adaptive filtering are combined in a dynamic fashion to form a “hybrid” communication scheme for an OFDM time-reversal system. Block 505 represents the processing performed to obtain channel state information. Graph 506, below the block 505, shows an illustrative example of a channel transfer function between the TR-OFDM transmitter and a receiver. The channel transfer function here is the channel state information (CSI), shown as a function of propagation loss over frequency (H(f)), and may subsume factors such as TR and multipath gain.

Block 510 represents inversion of the CSI, so that thresholding may be applied in block 515. Graph 511 shows an illustrative example of the result of computational inversion of the exemplary CSI of the graph 506. The thresholding is based on application of a dynamic threshold 516, shown in graph 517. The OFDM subcarriers or bins with attenuation (the inverted CSI) exceeding the threshold 516, are not used for transmission; for example, they are stuffed with zeros or other pre-determined values. The subcarriers or bins with lower attenuation are subjected to inverse filtering, whereby the power transmitted on the used subcarriers is varied to compensate for the variation of the CSI, flattening the product of the transmitted power and the attenuation on a per-subcarrier basis. Thus, inverse filtering is used for the subcarriers below the CSI attenuation threshold (relatively low attenuation, relatively good performance), and matched filtering due to TR is used for the channels where the CSI attenuation is over the threshold (relatively high attenuation, relatively poor performance). In embodiments, the subcarriers utilizing matched filtering may have their respective modulation order lowered, for example, to maintain the overall system bit error rate. Subcarriers with very high attenuation may be zero- (or other predetermined value-) stuffed, and thus not utilized for data transmission. Graph 518 shows an illustrative example of the hybrid filter result.

In operation, when the channel has good SNR and all the subcarriers are subjected to attenuation below the threshold (that is, the attenuation is relatively low across the subcarriers of the channel), the system may operate solely with inverse filtering. When the SNR drops and all the subcarriers are subjected to attenuation above the threshold (that is, the attenuation is relatively high), the system may operate with matched filtering (inherent in TR). In-between, where some subcarriers are subjected to relatively high attenuation and others are subjected to relatively low attenuation, the “good” subcarriers may be inverse-filtered, and the other subcarriers may be match-filtered.

Let us now turn to the selection of the appropriate threshold, such as the threshold 516 in FIG. 5. At a given order of Quadrature Amplitude Modulation, the energy per bit to noise power spectral density ratio (a normalized signal-to-noise ratio measure) E_{b}/N₀ needed to reach a target symbol error rate (SER) on an Adaptive White Gaussian Noise (AWGN) channel may be calculated using the following formula 1 below:

$$S E R \approx 2 erfc ( \sqrt{\frac{3 R}{2 ( {2}^{R} - 1 )} \cdot \frac{{E}_{b}}{{N}_{0}}} ) ,$$

where R stands for the number of bits per QAM symbol.

Rearranging this formula to obtain an expression for E_{b}/N₀ results in formula 2 below:

$$\frac{{E}_{b}}{{N}_{0}} \approx \frac{2 ( {2}^{R} - 1 )}{3 R} \cdot {[ {erfc}^{- 1} ( \frac{SER}{2} ) ]}^{2} .$$

Thus, to reach an SER of 10⁻⁵ for QPSK modulation without forward error correction, for example, the system may need E_{b}/N₀ of about 11 dB. The SER value may generally depend on the selected modulation and forward error correction techniques.

In selected embodiments, the maximum SER is set for each subcarrier and the order of modulation (number of bits R) is selected. Then, for each subcarrier, the E_{b}/N₀ is calculated from the channel sounding. For the subcarriers that have E_{b}/N₀ at or above the limit computed through the use of formula 2 (i.e., the subcarriers with relatively low attenuation), the system is configured to use inverse filtering. For the other subcarriers, which have E_{b}/N₀ below the limit computed through the use of formula 2 (i.e., the subcarriers with relatively high attenuation), the system is configured to use matched filtering inherent in TR.

By selecting the “good” carriers with SNR above the threshold, the number of bits used to generate per frame may be calculated as follows: NB_bits=R*NB_OFDM_Symb/frame*NB_Selected_Carriers. The calculation of the ratio E_{b}/N₀ for the obtained system may also be correlated with the SNR and bitrate according to the following formula 3:

$$\frac{{E}_{b}}{{N}_{0}} = SNR + 10 {log}_{10} ( \frac{BW}{Bitrate} ) ,$$

where BW is the bandwidth of the signal. Then, the bitrate may be computed as the ratio between the number of transmitted data symbols in an OFDM symbol and the duration of an OFDM symbol in seconds.

For some single-user case systems, the analysis of N_{T}×N_{R} MIMO system, where N_{R}≤N_{T}, shows that closely spaced antennas with substantially the same radiation patterns may not support uncorrelated channels to leverage the multipath TR gain.

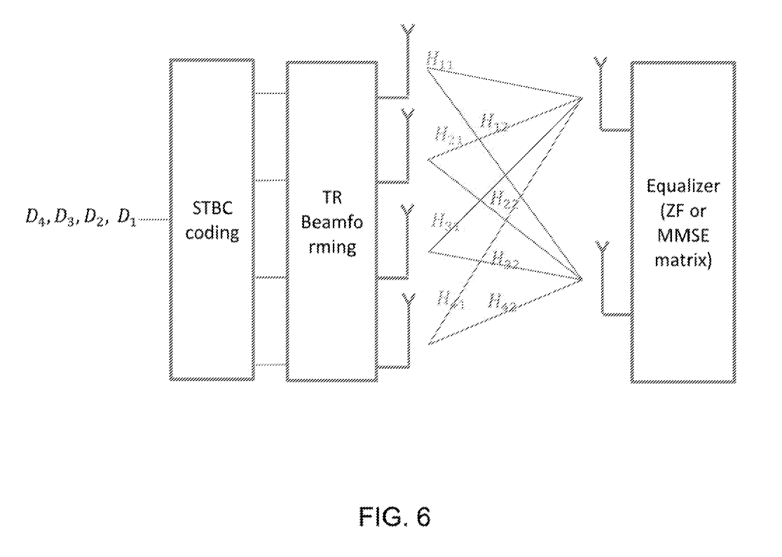

FIG. 6 illustrates an example of a TR-MIMO system operation in the time-domain, where Ns symbols are transmitted simultaneously over each of the Tx antennas by using the TR pre-filtering derived from the CIR between the i^{th} Rx and j^{ith} Tx antennas. If the antennas are closely spaced and have identical radiation patterns, then most of the CIR should be identical at the receiver, which means the pre-filtering coefficients will be also the same (or close to being the same), leading to high inter-symbol-interference (ISI) at the receiver. Hence, for closely spaced antennas the radiation patterns and polarizations should be carefully selected in order to lower the channel correlation numbers.

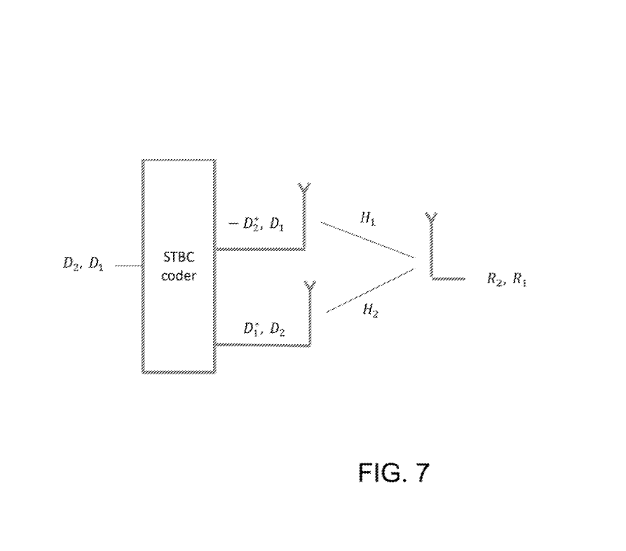

For TR-OFDM-MIMO example, let us consider a 4×2 system where the data symbols can be retrieved using either Zero Forcing equalizer: (H^{H} H)⁻¹H^{H}, or MMSE equalizer H^{H}(H^{H}H+σₙ²I_{N}_{_{T}})⁻¹, where σ_{N}_{_{T}}² is the noise power and N_{T} is the number of transmit antennas. Time-Reversal may be integrated with or without STBC by implementing a Sounding Phase and a TR pre-filtering Phase, as has already been described. In the Sounding Phase, an Rx antenna (e.g., one antenna at a time) sends a sounding single, which should be received by the N_{T} Tx antennas. During this step, the transmitter learns about the multipath channel through a sounding pulse sent by the receiver. In the TR pre-filtering Phase, each transmitter applies the TR H*(kΔf) pre-filter and sends data (same data stream over all the Tx antennas, for example). In order to perform the second phase, the Tx chains may need to be modified to realize the bit loading by implementing the modulator/demodulator for every constellation size to calculate the TR pre-filter and deduce the SNR on each subcarrier, suitable constellation to achieve the target SNR, and the number of bits for the OFDM symbols. In the case STBC is used, we may consider only one subcarrier of the OFDM system, as is illustrated in FIG. 7. Typically, the channel is considered to be (approximated as) time invariant during the two symbol durations D1 and D2.

The received symbols can be expressed as:

$$[ \begin{matrix}{R}_{1} \\ {R}_{2}^{*}\end{matrix} ] = [ \begin{matrix}{H}_{1} & {H}_{2} \\ {H}_{2}^{*} & - {H}_{1}^{*}\end{matrix} ] [ \begin{matrix}{D}_{1} \\ {D}_{2}\end{matrix} ]$$

And the data symbols can be retrieved by multiplying the received symbol by the transpose conjugate of the channel matrix:

$$[ \begin{matrix}{\hat{D}}_{1} \\ {\hat{D}}_{2}\end{matrix} ] = [ \begin{matrix}{H}_{1}^{*} & {H}_{2} \\ {H}_{2}^{*} & - {H}_{1}\end{matrix} ] [ \begin{matrix}{H}_{1} & {H}_{2} \\ {H}_{2}^{*} & - {H}_{1}^{*}\end{matrix} ] [ \begin{matrix}{D}_{1} \\ {D}_{2}\end{matrix} ] = [ \begin{matrix}{\vert {H}_{1} \vert}^{2} + {\vert {H}_{2} \vert}^{2} & 0 \\ 0 & {\vert {H}_{1} \vert}^{2} + {\vert {H}_{2} \vert}^{2}\end{matrix} ] [ \begin{matrix}{D}_{1} \\ {D}_{2}\end{matrix} ] .$$

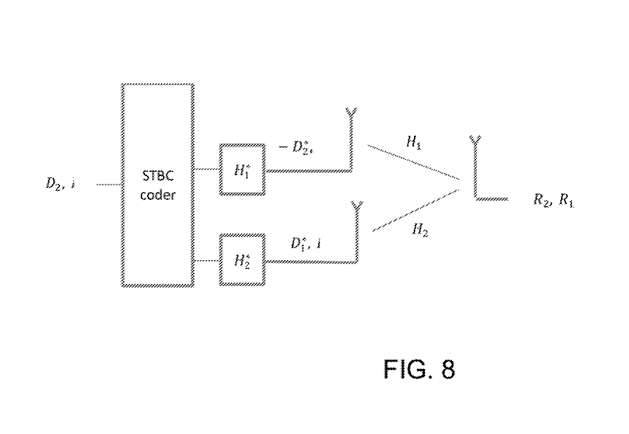

By adding TR on top of the STBC coder (FIG. 8), the estimated symbols can now be expressed as:

$$[ \begin{matrix}{\hat{D}}_{1} \\ {\hat{D}}_{2}\end{matrix} ] = [ \begin{matrix}{\vert {H}_{1} \vert}^{4} + {\vert {H}_{2} \vert}^{4} & 0 \\ 0 & {\vert {H}_{1} \vert}^{4} + {\vert {H}_{2} \vert}^{4}\end{matrix} ] [ \begin{matrix}{D}_{1} \\ {D}_{2}\end{matrix} ] .$$

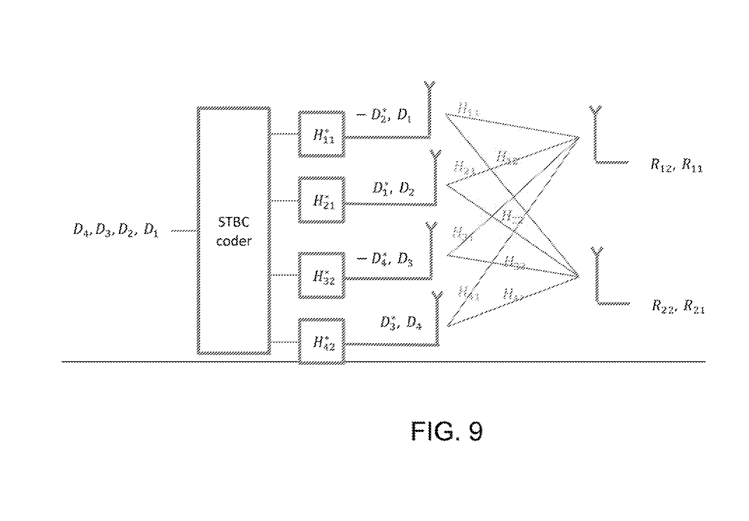

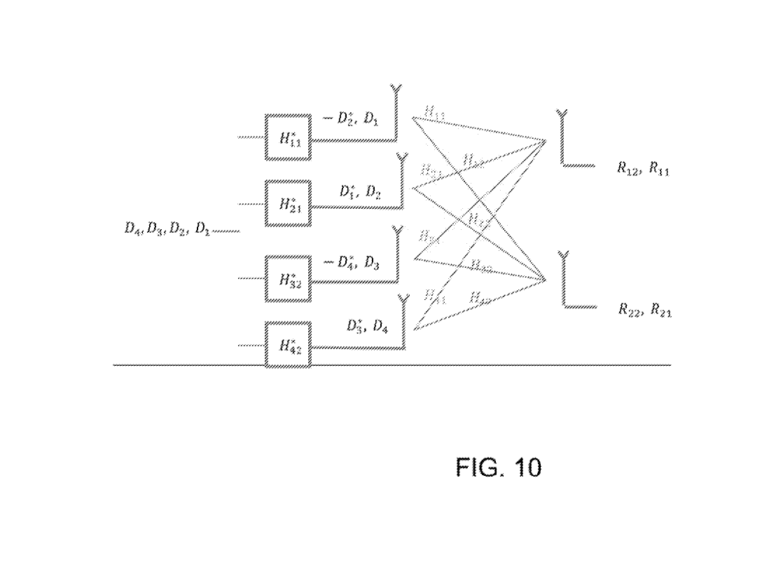

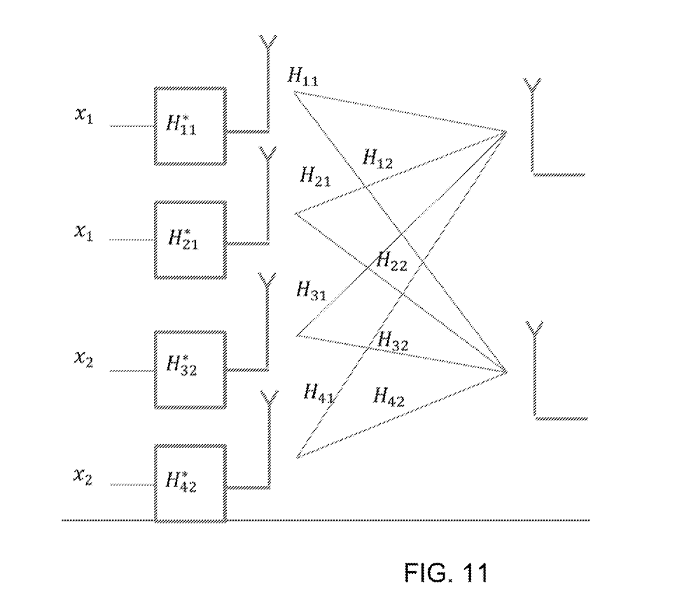

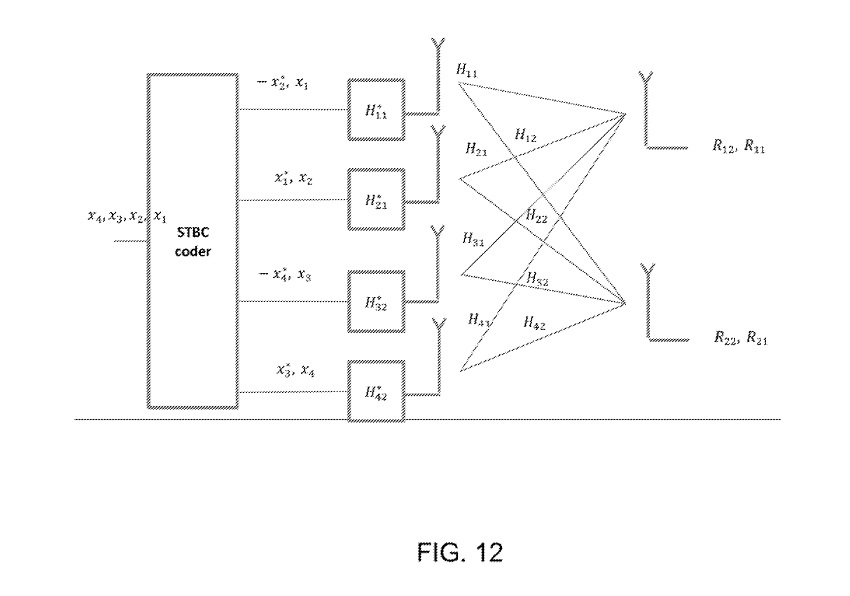

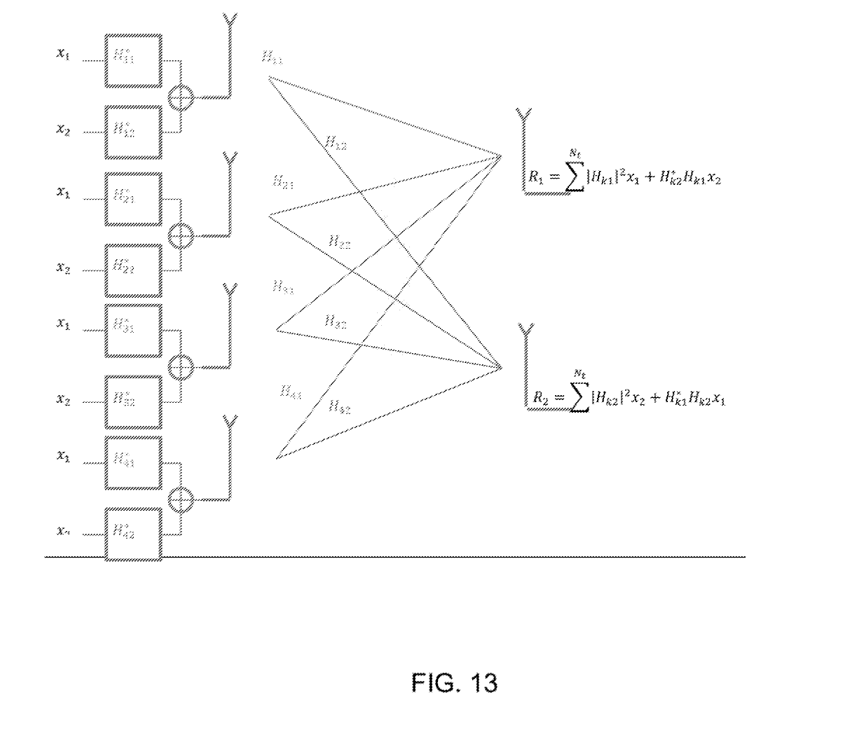

FIGS. 9 and 10 illustrate the cases with and without STBC coding, respectively. Other examples of MIMO coding schemes are illustrated in FIG. 11 (Coding scheme 2 where Coding scheme 1 each symbol is sent over two antennas, where beamforming is realized over pairs of transmit antennas, and no STBC coding is used); FIG. 12 (Coding scheme 1 where and STBC coder is used to map the symbols to the antennas); and FIG. 13 (Coding scheme 0 where two symbols are sent over each antenna, and where beamforming realized over all the transmit antennas and no STBC coding).

In the TR MIMO system models shown, D₁, D₂, D₃, D₄ are data symbols and Hᵢⱼ represents the channel between the i-th transmit antenna and the j-th receive antenna. Time Reversal beamforming can be realized with beamforming on all the antennas and beamforming on pairs of antennas. Note that the labeling of Tx and Rx antennas in the Figures need not reflect their physical order in the radio. For instance, the spacing between antenna 1 and antenna 4 can be smaller than the spacing between antenna 1 and antenna 2. The STBC may be used or not used. The signals may propagate over the multipath channels, and each Rx antenna may receive multiple copies of the data transmitted by each transmit antenna.

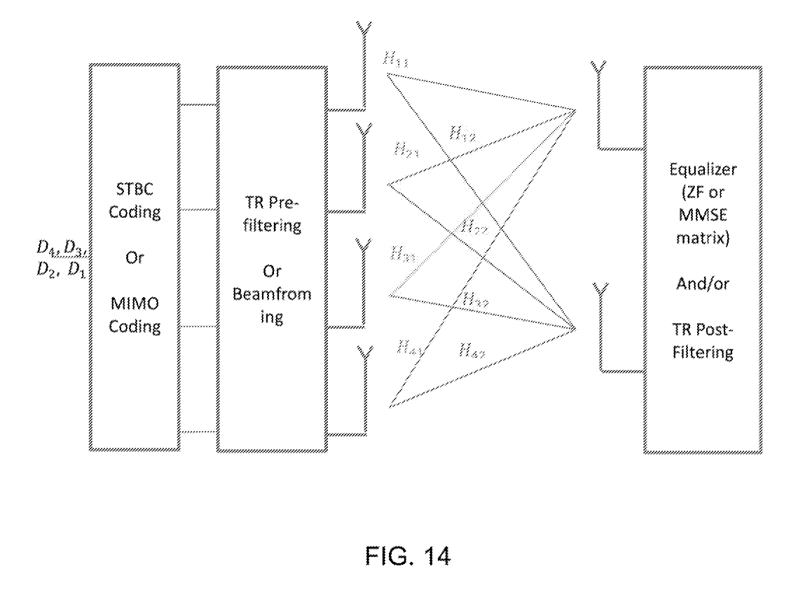

FIG. 14 illustrates an example of a general implementation of TR in a MIMO system for increased spectral efficiency or higher number of user density employing beamforming. In an adaptive implementation, various algorithms may be built into the system, such as: Channel assessment using sounding and TR-CIR; TR pre-filtering; TR beamforming on all antennas or a subset of antennas; STBC; MIMO Coding; TR pre-filtering; Equalizer at the receiver using Zero Forcing or MMSE; TR post-filtering; subcarrier selection at the transmitter to send more data on OFDM carrier with high SNR above a threshold, and others. The system may be configured to select the best (or any) set (permutation) of algorithms based on the channel conditions, number of antennas, user density, mobility, quality of service, type and amount of data to be transmitted, and/or others. The algorithms may be selected dynamically, as the conditions change. The conditions may be evaluated continually, at predetermined times, periodically, or otherwise, and the algorithms selected or changed as is needed.

In many systems, including those operating under 802.11n and 11ac standards, the channel sounding is realized by the Access Point by sending the Neighbor Discovery Packet (NDP) announcement followed by an NDP frame. As the channel is reciprocal between the Access Point and the client, both will have a similar, but not necessarily identical, channel estimate. Differences between client and Access Point can arise from noise or radio non-idealities. The clients can directly send their quantized estimate of the channel, or to reduce overhead, a reconciliation process can be used. In a reconciliation process, a client may send a checksum function of the client's quantized channel estimate, allowing both Access Point and the client to compute an identical channel estimate given small differences in the initial estimate. In either of these ways, both the clients and the AP may obtain identical quantized CSI information. Since TR could reduce the number of bits to be sent to the AP, it can reduce the feedback of all the users in the cell and thus reduce the time necessary to get the CSI for all the clients. Furthermore, the saturation throughput may depend on the feedback frame, which may contain 40+(N_{R}*NDSC*Q) bits, where N_{R} is the number of antennas of the clients, NDSC is the number of data subcarriers, and Q is the number of quantization bits. Assume N_{R}=8 and operation on a bandwidth of 160 MHz, NDSC=468 and the feedback frame contains 29992 bits, which corresponds to a duration of approximately 187 μs. Hence, a reduction in the CSI quantization levels should lower the multi-users overhead.

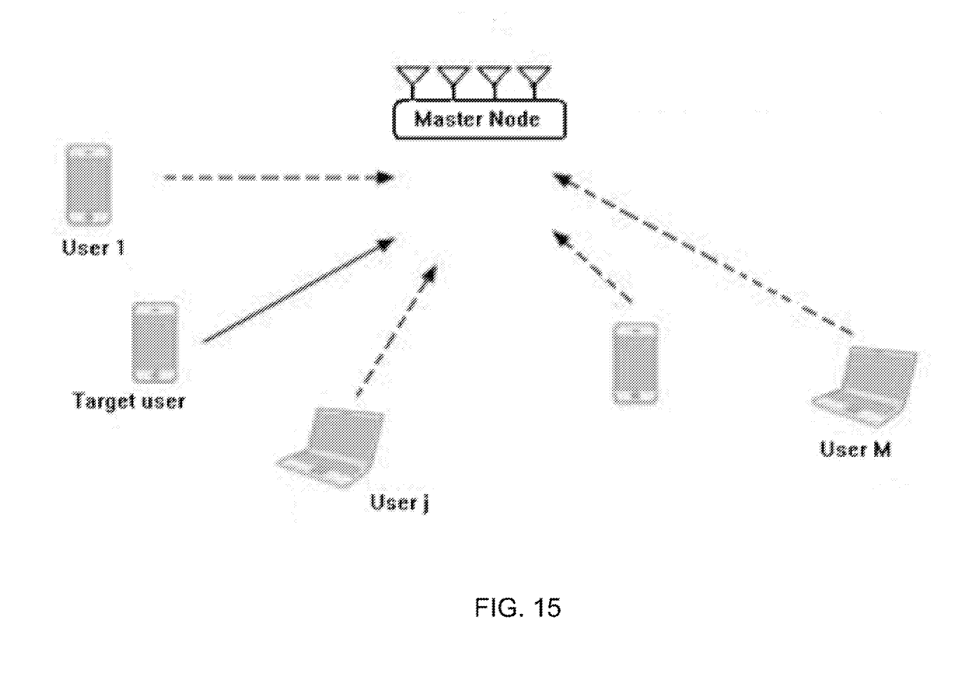

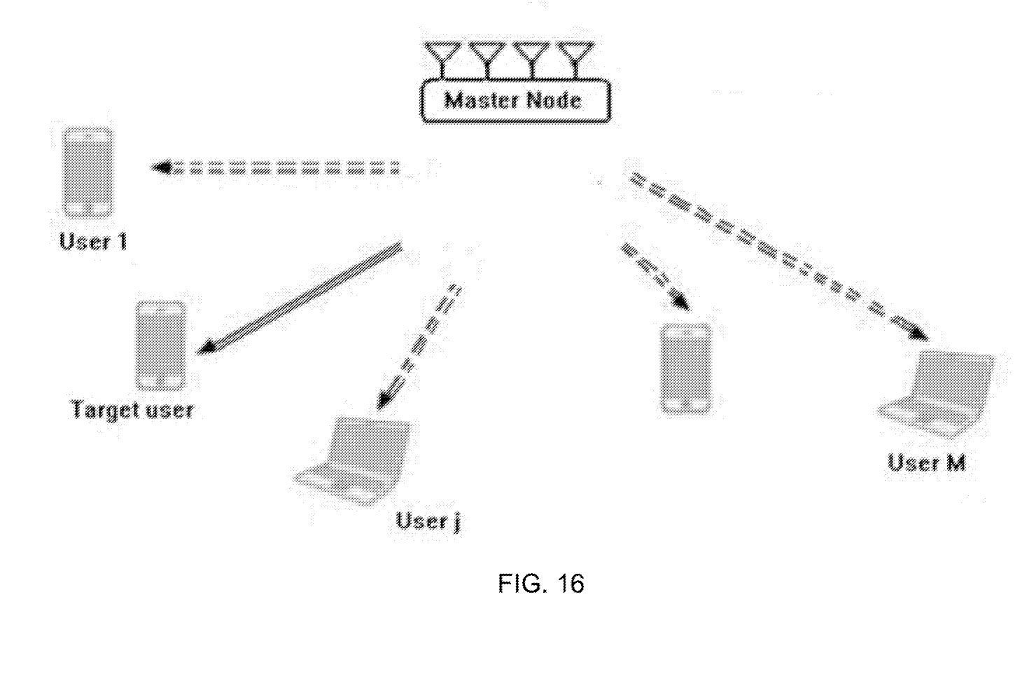

It may be advantageous in a multi-user system to initiate sounding from the client side, rather than from the Access Point side. Thus, a client device may send a sounding signal. In an example multi-user system illustrated in FIGS. 15 and 16, each client (user) device transmits (FIG. 15) its channel sounding signal to the AP or master node, with the client device closest to the AP sending its sounding signal first. If two client devices are located at the same distance from the AP, the AP may receive both their sounding signals at the same time and hence it might not be able to extract the CR/CIR or other CSI associated with each of the two client devices. Hence, the AP may send a request for each client to re-send its sounding pulse separately. The CIRᵢ of the sounding pulse transmitted by the target client device may be received by the multiple antennas i=1, 2, . . . N_{T} of the AP. The AP may quantize the CIRs of all or some of the client devices, compute their autocorrelation and cross-correlation functions to select the subset of antennas to use when sending downlink data to the target user (FIG. 16) after applying the TR pre-filtering based on the selected CIRs. In some instances, it could be determined that each antenna can be used to communicate with different user simultaneously if their corresponding CIRs are semi-orthogonal. Furthermore, the AP may send the quantized CIR back to the target client in order for the latter to use it in its TR pre-filtering when sending uplink data back to the AP. Such sounding approach may be more suitable for TR communications, since the AP generally has more antennas than the users/client devices.

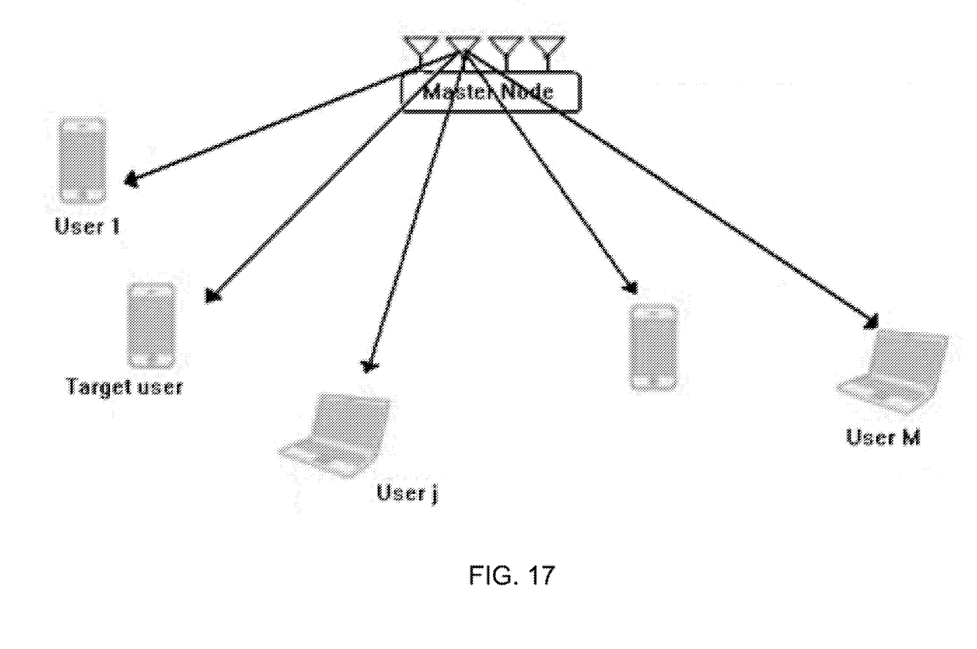

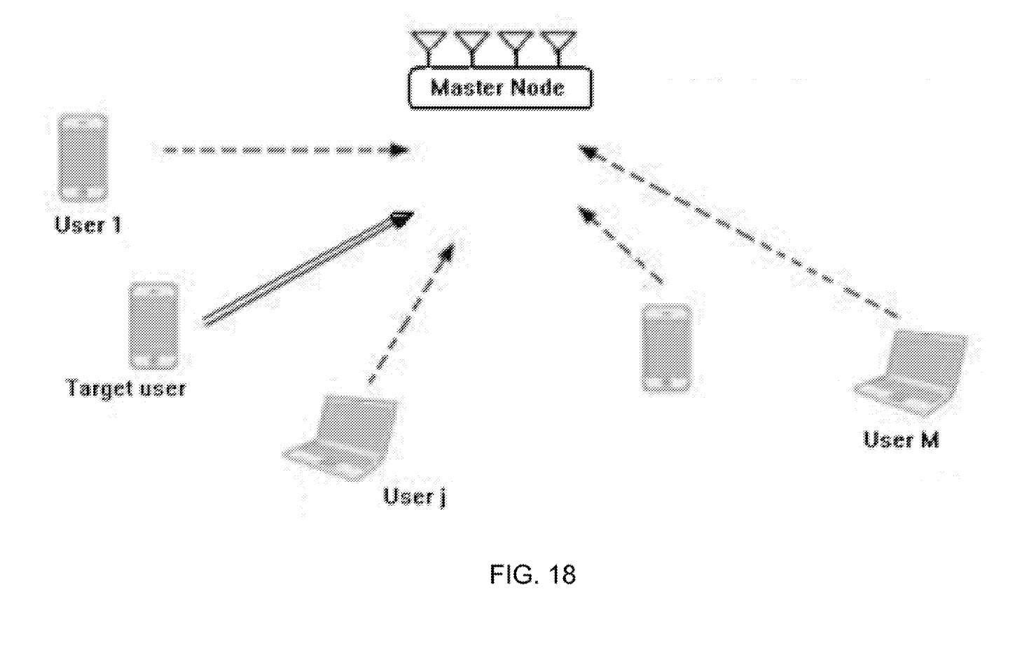

In another example of multi-user system illustrated in FIGS. 17 and 18, the AP sequentially transmits (FIG. 17) a sounding signal from each of its antennas to all client devices in the AP's cell. The client devices derive the CIRs between the AP antennas and their own antennas to compare and select the channel, for example, a channel with the best autocorrelation and/or cross-correlation value(s). Each client device transmits its quantized CIR and the TR pre-filtered data to the AP (FIG. 18). Then, the AP compares the quantized CIRs received from all the client devices to determine the subset of antennas to use when communicating with a target client device. Depending on the cross-correlation between the CIRs of different client devices, the AP may or may not allow simultaneous downlink and uplink data stream from particular client devices.

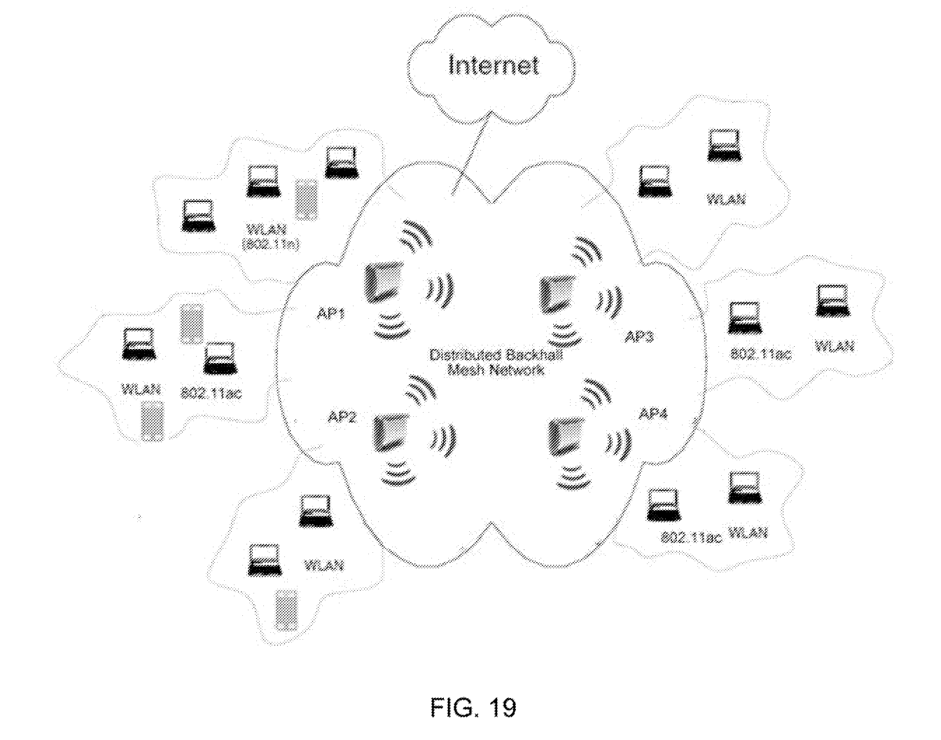

FIG. 19 illustrates an example of aggregation of multiple Access Points in a distributed manner to act as a backhaul in a multi-user network.

In an embodiment, mesh nodes are equipped with at least two PHY interfaces: a first one (802.11ac at 5 GHz as an example) may be used to communicate with mesh nodes, and a second PHY interface (such as 2.4 GHz IEEE 802.11n) may be used to communicate with the associated stations of each mesh node WLAN. Furthermore, an extension of request-to-send/clear to-send (RTS/CTS) schemes are also developed to integrate the TR channel sounding and pre-coding schemes to support the TR-MU-MIMO such as the following:

1. Switching between two modes. By using TR, the system switches between CSI estimation mode and data transmission mode. A node which wins the channel is able to send frames to multiple receivers. A back-off (BO) starts to count down. As soon as a node's BO first reaches zero, it simultaneously transmits multiple A-MPDUs (Aggregate MAC Protocol Data Units).

2. Stream-greedy algorithm. Such algorithm tries to maximize the number of spatial streams (Ns) assigned to a beam, taking into account that the maximum number is limited by the number of antennas of each side and multipath density. The duration of a transmission is reduced if more spatial streams are assigned to a beam. Denoting the number of beams by Nb and the number of spatial streams by Ns, each beam may contain multiple special streams such that the total Nb*Ns does not exceed the number of antennas.

3. Beam-greedy algorithm. TR tries to maximize the number of parallel channels. This scheme tries to increase the number of nodes that can simultaneously receive A-MPDUs, which makes the transmission more efficient as the PHY headers are also transmitted in parallel. However, the channel may remain busy for a longer period because the duration each transmission is longer, thus reducing the frequency with which the nodes can transmit new frames.

4. Stream-independent algorithm. Such algorithm considers that each spatial stream is independent and responsible for transmitting an A-MPDU, regardless of whether AMPDUs are destined to different nodes or to the same node. Nb≤min(M, min(n−1, 4)) reduces to Nb≤min(M, n−1). This scheduler aims to extend further the advantages of the Beam-greedy algorithm by removing the limitation on the number of beams that can be simultaneously transmitted.

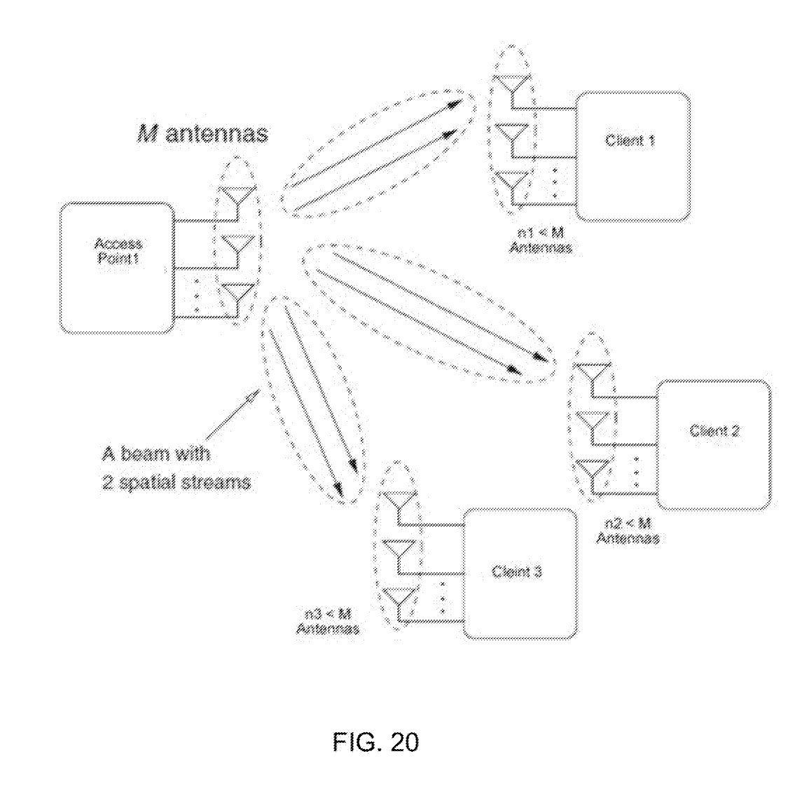

FIG. 20 is a high-level illustration of a multi-user network using multiple antennas on the Access Point and clients' sides.

In an example, a mesh network has n identical mesh nodes, each of which is equipped with M antennas. Frames destined to the same node are assembled into an A-MPDU and assigned to a designated beam to a client. Each beam may contain one or more spatial streams depending on the number of antennas on each side. The transmit duration when more spatial streams are involved is shorter than that of a beam with fewer spatial streams since the spectral efficiency may be lower in the latter one. In order to make all beams of a transmission to have the same duration, a node may assign the same number of spatial streams to different beams in each transmission.

Adaptive scheduling algorithm may use various TR, PHY, System and Networking parameters, such as spatial stream/frame allocation, the number of nodes/antennas, and the size of A-MPDU, the channel bandwidth, the queueing state, and the interference conditions. It also may minimize (or reduce) the frequency of channel sounding, maximize (or increase) the system throughput, and attempt not being unfair to the active nodes.

Multi-packet reception (MPR) may be employed to allow a node to transmit simultaneously frames to multiple nodes. Synchronization among distributed nodes may make the MURTS/CTS handshaking process a better candidate than the MU-Basic to be extended to support MPR.

Non-saturated conditions where the channel sounding is optimized to reduce overhead, for example, an on-demand CSI request may be sent to some specified nodes only when the transmitter has frames directed to them, while a more complex option can be a node caching the obtained CSI for a predefined time and only requesting the CSI updates if the node has frames to send and the cached CSI is outdated.

Multi-hop mesh networks may use TR.

Another technique includes slightly offsetting in time the transmissions of each user so as to reduce the multi-user interference. An offset interval can be found so as to minimize the interference between/among users.

Still another technique is Joint Time Reversal and Zero Forcing pre-equalization to nullify (or reduce) both Inter-Symbol Interference and Multi-Stream Interference, keeping the receivers complexity low, and maximizing the power at the receiver.

In order to study the quality of the equivalent channel impulse response when the CSI is available on a fixed quantized number of bits, the following steps may be performed:

1. Quantize the CSI and then compute its autocorrelation and cross-correlation with the real channel impulse response.

2. Compute the FFT of the autocorrelation and the cross-correlation.

3. Measure the Peak power and the ratio between the peak power of the cross-correlation and autocorrelation.

4. Measure the Mean Square Error of the modulus of the channel in the time domain, Mean Square Error of the modulus of the channel in the frequency domain, and Mean Square Error of the angle of the channel in the frequency domain.

5. Send beamforming feedback by clients to the Access Point with the following information on the frequency domain CIR: The average SNR of the CIR and the angles of the CIR on the subcarriers, where the number of angles and their precision depends on the number of antennas. For example, for a 2×2 system two angles per subcarrier are available, for a 3×3 system six angles/subcarrier, and for a 4×4 system twelve angles/subcarrier. Furthermore, for a single client 6 or 10 bits/angle quantization may be needed, and for multi-user 12 or 16 bits/angle.

6. Factoring in the number of subcarrier per each channel bandwidth: 20 MHz: 52 subcarriers, 40 MHZ: 108 subcarriers, 80 MHz: 234 subcarriers, 160 MHz: 486 subcarriers. The quantization of the angles may be performed as follows:

$$φ = \frac{k π}{{2}^{b} {φ}^{- 1}} + \frac{π}{{2}^{b} φ} ,$$

where k=0, 1, . . . , 2^{b}ϕ−1 and b_{ϕ} is the number of bits to quantize ϕ.

Lack of Knowledge on the Feedback.

The definition of the angles is not stated in the standard: the articles that should detail the angles and their selection are not present. For some configurations, the feedback is not realized on all the data carriers. Hence, an interpolation may be done at the Access Point. This interpolation is also not present in the standard. The number of angles does not correspond to the total number of CIRs in the system; e.g., for the 2×2 system, only 2 angles may be sent back although 4 CIRs may be used in the system.

Orthogonal Frequency-Division Multiplexing systems may be implemented in conjunction with (1) guard bands to allow longer delay spread and limit inter symbol interference (ISI) in multipath environment; (2) cyclic prefix to limit inter carrier interference (ICI); and (3) error correction such as forward error correction (FEC) encoding, interleaving, puncturing, and MIMO coding to lower Bit Error Rates (BER). Although the use of guard bands, cyclic prefix, and FEC, may cause some loss in efficiency, it may provide more reliable communications. The extension of OFDM to time-reversal (TR) communications can also benefit from these techniques.

The features described throughout this document may be present individually, or in any combination or permutation, except where the presence or absence of specific elements/limitations is inherently required, explicitly indicated, or otherwise made clear from context.

Although the process steps and decisions (if decision blocks are present) may be described serially in this document, certain steps and/or decisions may be performed by same and/or separate elements in conjunction or in parallel, asynchronously or synchronously, in a pipelined manner, or otherwise. There is no particular requirement that the steps and decisions be performed in the same order in which this description lists them or the Figures show them, except where a specific order is inherently required, explicitly indicated, or is otherwise made clear from the context. Furthermore, not every illustrated step and decision block may be required in every embodiment in accordance with the concepts described in this document, while some steps and decision blocks that have not been specifically illustrated may be desirable or necessary in some embodiments in accordance with the concepts. It should be noted, however, that specific embodiments/variants/examples use the particular order(s) in which the steps and decisions (if applicable) are shown and/or described.

The instructions (machine executable code) corresponding to the method steps of the embodiments, variants, and examples disclosed in this document may be embodied directly in hardware, in software, in firmware, or in combinations thereof. A software module may be stored in volatile memory, flash memory, Read Only Memory (ROM), Electrically Programmable ROM (EPROM), Electrically Erasable Programmable ROM (EEPROM), hard disk, a CD-ROM, a DVD-ROM, or other form of non-transitory storage medium known in the art. Exemplary storage medium or media may be coupled to one or more processors so that the one or more processors can read information from, and write information to, the storage medium or media. In an alternative, the storage medium or media may be integral to one or more processors.

This document describes in detail the inventive apparatus, methods, and articles of manufacture for communications and other techniques using hybridized matched and inverse filtering. This was done for illustration purposes and, therefore, the foregoing description is not necessarily intended to limit the spirit and scope of the invention(s) described. Neither the specific embodiments of the invention(s) as a whole, nor those of its (or their) features necessarily limit the general principles underlying the invention(s). The specific features described herein may be used in some embodiments, but not in others, without departure from the spirit and scope of the invention(s) as set forth herein. Various physical arrangements of components and various step sequences also fall within the intended scope of the invention(s). Many additional modifications are intended in the foregoing disclosure, and it will be appreciated by those of ordinary skill in the pertinent art that in some instances some features will be employed in the absence of a corresponding use of other features. The embodiments described above are illustrative and not necessarily limiting, although they or their selected features may be limiting for some claims. The illustrative examples therefore do not necessarily define the metes and bounds of the invention(s) and the legal protection afforded the invention(s).

What is claimed is:

1. A method of wirelessly communicating between a first node and a second node using Radio Frequency (RF) Orthogonal Frequency-Division Multiplexing (OFDM) with a plurality of subcarriers and time-reversal, the method comprising:
estimating channel between the first node and the second node for each subcarrier of the plurality of subcarriers, thereby obtaining a plurality of channel state information (CSI) estimates, a CSI estimate of the plurality of CSI estimates per subcarrier of the plurality of subcarriers, each subcarrier of the plurality of subcarriers being associated with a CSI estimate of the plurality of CSI estimates corresponding to said each subcarrier; and
transmitting data from the first node to the second node using inverse filtering for subcarriers of the plurality of subcarriers associated with CSI estimates that meet at least one channel quality criterion, and matched filtering for subcarriers of the plurality of subcarriers associated with CSI estimates that do not meet the at least one channel quality criterion.

2. A method of wirelessly communicating as in claim 1, wherein the first node comprises an access point configured to communicate with a plurality of client devices, the plurality of client devices comprising the second node.

3. A method of wirelessly communicating as in claim 1, wherein the step of estimating comprises transmitting a sounding signal from the second node to the first node.

4. A method of wirelessly communicating as in claim 1, wherein the step of estimating comprises receiving by the first node a sounding signal transmitted from the second node.

5. A method of wirelessly communicating as in claim 1, wherein inverse filtering is performed so that total transmitted power is subjected to a transmit power constraint imposed on the first node.

6. A method of wirelessly communicating as in claim 1, wherein matched filtering is performed so that at least some of the subcarriers that do not meet the at least one channel quality criterion are stuffed with a predetermined value.

7. A method of wirelessly communicating as in claim 1, wherein the step of transmitting comprises sending the data from the first node to the second node using inverse filtering for the subcarriers of the plurality of subcarriers associated with the CSI estimates that meet the at least one channel quality criterion, and
using matched filtering with reduced modulation order for at least some of the subcarriers associated with the CSI estimates that do not meet the at least one channel quality criterion.

8. A method of wirelessly communicating as in claim 1, wherein:
the at least one channel quality criterion comprises a channel attenuation threshold;
each CSI estimate of the plurality of CSI estimates comprises a channel attenuation estimate corresponding to the subcarrier associated with said each CSI estimate; and
CSI estimates that meet the at least one channel quality criterion indicate attenuation less than the channel attenuation threshold, and CSI estimates that do not meet the at least one channel quality criterion indicate attenuation not less than the channel attenuation threshold.

9. A method of wirelessly communicating as in claim 1, further comprising:
setting a target symbol error rate (SER); and
computing the at least one channel quality criterion based on the target SER.

10. A method of wirelessly communicating as in claim 1, wherein:
the at least one channel quality criterion comprises a normalized signal-to-noise ratio threshold;
each CSI estimate of the plurality of CSI estimates comprises a channel normalized signal-to-noise ratio estimate corresponding to the subcarrier associated with said each CSI estimate;
CSI estimates that meet the at least one channel quality criterion indicate normalized signal-to-noise ratio greater than the normalized signal-to-noise ratio threshold
$$( TH \frac{{E}_{b}}{{N}_{0}} ) ,$$
and CSI estimates that do not meet the at least one channel quality criterion indicate normalized signal-to-noise ratio not greater than the normalized signal-to-noise ratio threshold
$$( TH \frac{{E}_{b}}{{N}_{0}} ) .$$

11. A method of wirelessly communicating as in claim 1, wherein the step of transmitting is performed using Quadrature Amplitude Modulation (QAM) technique, the method further comprising:
setting a target symbol error rate (TSER) for said each subcarrier; and
computing the normalized signal-to-noise ratio threshold
$$TH \frac{{E}_{b}}{{N}_{0}}$$
based on the TSER according to the following formula:
$$TH \frac{{E}_{b}}{{N}_{0}} = \frac{2 ( {2}^{R} - 1 )}{3 R} \cdot {[ {erfc}^{- 1} ( \frac{TSER}{2} ) ]}^{2} ,$$
wherein R is the number of bits in the QAM.

12. A method of wirelessly communicating as in claim 10, further comprising:
setting a target symbol error rate (TSER) for said each subcarrier; and
step for computing the channel normalized signal-to-noise ratio threshold
$$( TH \frac{{E}_{b}}{{N}_{0}} ) ,$$
based on the TSER.

13. A Radio Frequency (RF) wireless communication node comprising a receiver, a transmitter, a storage device storing program code, and a processor, wherein the processor is coupled to the receiver, the transmitter, and the storage device to read the program code from the storage device and execute the program code to configure the communication node to
estimate channel between the communication node and another node for a plurality of Orthogonal Frequency-Division Multiplexing (OFDM) subcarriers, thereby obtaining a plurality of channel state information (CSI) estimates, a CSI estimate of the plurality of CSI estimates per subcarrier of the plurality of subcarriers, each subcarrier of the plurality of subcarriers being associated with a CSI estimate of the plurality of CSI estimates corresponding to said each subcarrier; and
transmit data to said another node using inverse filtering for subcarriers of the plurality of subcarriers associated with CSI estimates that meet at least one channel quality criterion, and matched filtering for subcarriers of the plurality of subcarriers associated with CSI estimates that do not meet the at least one channel quality criterion.

14. A Radio Frequency (RF) wireless communication node as in claim 13, wherein the communication node is an access point configured to communicate with a plurality of client devices, the plurality of client devices comprising said another node.

15. A Radio Frequency (RF) wireless communication node as in claim 13, wherein the processor executes the program code further to configure the communication node to estimate the channel based on a sounding signal received from said another node.

16. A Radio Frequency (RF) wireless communication node as in claim 13, wherein the processor executes the program code further to configure the communication node to estimate the channel by receiving information from said another node, the information from said another node being based on a sounding signal transmitted from the communication node to said another node.

17. A Radio Frequency (RF) wireless communication node as in claim 13, wherein the processor executes the program code further to configure the communication node so that total transmitted power from the communication node is subjected to a predetermined transmit power constraint.

18. A Radio Frequency (RF) wireless communication node as in claim 13, wherein the processor executes the program code further to configure the communication node so that at least some of the subcarriers that do not meet the at least one channel quality criterion are stuffed with a predetermined value.

19. A Radio Frequency (RF) wireless communication node as in claim 13, wherein the processor executes the program code further to configure the communication node so that the data is transmitted using inverse filtering for the subcarriers of the plurality of subcarriers associated with the channel estimates that meet the at least one channel quality criterion, and using matched filtering with reduced modulation order for at least some of the subcarriers of the plurality of subcarriers associated with the channel estimates that do not meet the at least one channel quality criterion.

20. A Radio Frequency (RF) wireless communication node as in claim 13, wherein the processor executes the program code further to configure the communication node so that
the at least one channel quality criterion comprises a channel attenuation threshold;
each CSI estimate of the plurality of CSI estimates comprises a channel attenuation estimate corresponding to the subcarrier associated with said each CSI estimate; and
CSI estimates that meet the at least one channel quality criterion indicate attenuation less than the channel attenuation threshold, and CSI estimates that do not meet the at least one channel quality criterion indicate attenuation not less than the channel attenuation threshold.

21. A Radio Frequency (RF) wireless communication node as in claim 13, wherein the processor executes the program code further to configure the communication node to compute the at least one channel quality criterion based on a target symbol error rate.

22. A Radio Frequency (RF) wireless communication node as in claim 13, wherein the transmitter uses Quadrature Amplitude Modulation (QAM), and the processor executes the program code further to configure the communication node so that
the at least one channel quality criterion comprises a normalized signal-to-noise ratio threshold
$$( TH \frac{{E}_{b}}{{N}_{0}} ) ;$$
each CSI estimate of the plurality of CSI estimates comprises a channel normalized signal-to-noise ratio estimate corresponding to the subcarrier associated with said each CSI estimate;
CSI estimates that meet the at least one channel quality criterion indicate normalized signal-to-noise ratio greater than the normalized signal-to-noise ratio threshold
$$( TH \frac{{E}_{b}}{{N}_{0}} ) ,$$
and CSI estimates that do not meet the at least one channel quality criterion indicate normalized signal-to-noise ratio not greater than the normalized signal-to-noise ratio threshold
$$( TH \frac{{E}_{b}}{{N}_{0}} ) .$$

23. A Radio Frequency (RF) wireless communication node as in claim 13, wherein the transmitter uses Quadrature Amplitude Modulation (QAM), and the processor executes the program code further to configure the communication node to
set a target symbol error rate (TSER); and
compute the normalized signal-to-noise ratio threshold
$$TH \frac{{E}_{b}}{{N}_{0}}$$
based on the TSER according to the following formula:
$$TH \frac{{E}_{b}}{{N}_{0}} = \frac{2 ( {2}^{R} - 1 )}{3 R} \cdot {[ {erfc}^{- 1} ( \frac{TSER}{2} ) ]}^{2} ,$$
wherein R is the number of bits in the QAM.

25. An article of manufacture comprising non-transient machine-readable storage medium with program code stored in the medium, the program code, when executed by at least one processor of a first node comprising an antenna, a radio frequency transceiver coupled to the antenna, and a processor coupled to the transceiver to control operation of the transceiver, configures the node to communicate wirelessly with a second node using Radio Frequency (RF) Orthogonal Frequency-Division Multiplexing (OFDM) with a plurality of subcarriers and time-reversal, by performing steps comprising:
estimating channel between the first node and the second node for each subcarrier of the plurality of subcarriers, thereby obtaining a plurality of channel state information (CSI) estimates, a CSI estimate of the plurality of CSI estimates per subcarrier of the plurality of subcarriers, each subcarrier of the plurality of subcarriers being associated with a CSI estimate of the plurality of CSI estimates corresponding to said each subcarrier; and
transmitting data from the first node to the second node using inverse filtering for subcarriers of the plurality of subcarriers associated with CSI estimates that meet at least one channel quality criterion, and matched filtering for subcarriers of the plurality of subcarriers associated with CSI estimates that do not meet the at least one channel quality criterion.

26. A wireless Radio Frequency (RF) communication node comprising a receiver, a transmitter, a storage device, and a processor, wherein the processor is coupled to the receiver, the transmitter, and the storage device to read program code from the storage device and execute the program code to configure the communication node to
obtain estimates of channel between the communication node and another node for a plurality of Orthogonal Frequency-Division Multiplexing (OFDM) subcarriers;
receive data from said another node using inverse filtering for subcarriers of the plurality of subcarriers that meet one or more channel quality criteria, and using Time-Reversal matched filtering for subcarriers of the plurality of subcarriers that do not meet the one or more channel quality criteria.
